(19) United States
(12) Patent Application Publication
(10) Pub. No.: US 2008/0084769 A1
(43) Pub. Date: Apr. 10, 2008

(54) Memory system and method for operating a memory system

(76) Inventors: Siva RaghuRam, Germering (DE); Srdjan Djordjevic, Munchen (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/544,537

(22) Filed: Oct. 6, 2006

(51) Int. Cl. G06F 13/00

(52) U.S. Cl. 365/191; 711/170

(57) ABSTRACT

A memory system, in particular a buffered memory system, e.g. a fully buffered memory system, a method for operating a memory system, and a device for use with a memory system is disclosed. In one embodiment, the memory system includes at least one buffered memory module, and a device for generating a first and second chip select signal from one single chip select signal. Further, a device for use with a memory system is provided, generating a second number of chip select signals from a first number of chip select signals, the first number of chip select signals being smaller, than the second number of chip select signals.

### BACKGROUND

The invention relates to a memory system, in particular a buffered memory system, e.g. a fully buffered memory system, a method for operating a memory system, and a device for use with a memory system.

In the case of conventional memory devices, in particular conventional semiconductor memory devices, one differentiates between functional memory devices (e.g. PLAs, PALs, etc.), and table memory devices, e.g. ROM devices (ROM=Read Only Memory—in particular PROMs, EPROMs, EEPROMs, flash memories, etc.), and RAM devices (RAM=Random Access Memory—in particular e.g. DRAMs and SRAMs).

A RAM device is a memory for storing data under a predetermined address and for reading out the data under this address later. In the case of SRAMs (SRAM=Static Random Access Memory), the individual memory cells consist e.g. of few, for instance 6, transistors, and in the case of DRAMs (DRAM=Dynamic Random Access Memory) in general only of one single, correspondingly controlled capacitive element.

In many applications, several DRAMs are arranged on a single, separate memory module, e.g. a separate memory card. Further, several of such memory modules—each having several DRAMs—may be connected to a respective microprocessor or memory controller via a bus system. However, the higher the number of memory modules/DRAMs connected to the microprocessor/memory controller, and the higher the data rate, the worse the quality of the signals exchanged between the memory modules/DRAMs, and the microprocessor/memory controller.

For this reason, “buffered” memory modules are used, e.g., registered DIMMs. Buffered memory modules comprise—in addition to several DRAMs—one or several buffer components, receiving the signals from the microprocessor/memory controller, and relaying them to the respective DRAM (and vice versa). Hence, the respective memory controller only needs to drive one capacitive load per DIMM on the bus.

To further enhance the data rate, and/or the number of memory modules which may be connected to a respective microprocessor/memory controller, FBDIMMs (Fully Buffered DIMMs) are used.

FIG. 1 illustrates an example of a conventional memory system 1 with FBDIMMs 2a, 2b, 2c (Fully Buffered DIMMs). In the memory system 1 illustrated in FIG. 1, up to eight memory cards/FBDIMMs 2a, 2b, 2c per channel may be connected to a microprocessor/memory controller 4. Each FBDIMM 2a, 2b, 2c includes a buffer component 5a, 5b, 5c, and several DRAMs 3a, 3b, 3c, e.g., respective DDR2-DRAMs (for sake of simplicity, in FIG. 1 only one DRAM per memory card/FBDIMM 2a, 2b, 2c is illustrated).

Each FBDIMM 2a, 2b, 2c might e.g. comprise a first group of DRAMs (“first rank”), e.g. positioned at a front side (and/or a back side) of a respective FBDIMM 2a, 2b, 2c, and e.g. a second group of DRAMs (“second rank”), e.g. positioned at the back side (and/or the front side) of a respective FBDIMM 2a, 2b, 2c (“dual ranked” FBDIMMs).

The FBDIMMs 2a, 2b, 2c may e.g. be plugged into corresponding sockets of a motherboard, which, e.g., also includes the above microprocessor/memory controller 4.

As is illustrated in FIG. 1, the microprocessor/memory controller 4 may be connected to a first FBDIMM 2a of the FBDIMMs 2a, 2b, 2c via a first bus 6a, having a first channel (“south-bound channel” (SB channel)), and a second channel (“north-bound channel” (NB channel)). The SB channel of the bus 6a is used to send respective address, command, and data signals from the microprocessor/memory controller 4 to the buffer component 5a of the first FBDIMM 2a. Correspondingly similar, the NB channel of the bus 6a is used to send respective signals from the buffer component 5a of the first FBDIMM 2a to the microprocessor/memory controller 4.

As is further illustrated in FIG. 1, the first FBDIMM 2a of the FBDIMMs 2a, 2b, 2c is connected to a second FBDIMM 2b of the FBDIMMs 2a, 2b, 2c via a second bus 6b, which just as the bus 6a includes a first channel (“south-bound channel” (SB channel)), and a second channel (“north-bound channel” (NB channel)), and the second FBDIMM 2b of the FBDIMMs 2a, 2b, 2c is connected to a third FBDIMM via a third bus 6c (also having a first channel (“south-bound channel” (SB channel)), and a second channel (“north-bound channel” (NB channel)), etc., etc.

The FBDIMMs 2a, 2b, 2c work according to the “daisy chain” principle. The buffer component 5a of the first FBDIMM 2a of the FBDIMMs 2a, 2b, 2c relays the respective address, command, and data signals received via the “south-bound channel” of the first bus 6a from the microprocessor/memory controller 4—where required after a respective re-generation—via the “south-bound channel” of the second bus 6b to the buffer component 5b of the second FBDIMM 2b. Correspondingly similar, the buffer component 5b of the second FBDIMM 2b of the FBDIMMs 2a, 2b, 2c relays the respective address, command, and data signals received via the “south-bound channel” of the second bus 6b from the first FBDIMM 2a—where required after a respective re-generation—via the “south-bound channel” of the third bus 6c to the buffer component 5c of the third FBDIMM 2c, etc., etc.

Correspondingly inversely, the buffer component 5b of the second FBDIMM 2b of the FBDIMMs 2a, 2b, 2c relays the respective signals received via the “north-bound channel” of the third bus 6c from the above third FBDIMM—where required after a respective re-generation—via the “north-bound channel” of the second bus 6b to the buffer component 5a of the first FBDIMM 2a, and the buffer component 5a of the first FBDIMM 2a of the FBDIMMs 2a, 2b, 2c relays the respective signals received via the “north-bound channel” of the second bus 6b from the above second FBDIMM 2b—where required after a respective re-generation—via the “north-bound channel” of the first bus 6a to the microprocessor/memory controller 4.

As is further illustrated in FIG. 1, each DRAM 3a, 3b, 3c is connected to the corresponding buffer component 5a, 5b, 5c via a bus 7a, 7b, 7c, e.g., a respective stub-bus.

Each buffer component 5a, 5b, 5c knows its position in the above daisy chain. Which of the FBDIMMs 2a, 2b, 2c is being accessed at a certain time by the memory controller 4 may e.g. be determined in the respective buffer component 5a, 5b, 5c by comparing memory module identification data stored there (e.g., an “ID number”) with identification data sent by the memory controller 4 via the above buses 6a, 6b, 6c.

The buffer component 5a, 5b, 5c of an accessed FBDIMM 2a, 2b, 2c does not only relay the received address, command, and data signals via a respective south-bound channel of one of the buses 6a, 6b, 6c to the next buffer component in the daisy chain (as explained above), but also relays the signals (where appropriate, in converted form) via the above stub-bus 7a, 7b, 7c to the DRAMs 3a, 3b, 3c provided on the accessed FBDIMM 2a, 2b, 2c. Further, signals received by a respective buffer component 5a, 5b, 5c via the above stub-bus 7a, 7b, 7c from an accessed DRAM 3a, 3b, 3c are relayed (where appropriate, in converted form) via a respective north bound channel of one of the buses 6a, 6b, 6c to the previous buffer component in the daisy chain (or—by the buffer component 5a of the first the FBDIMM 2a—to the memory controller 4).

If a DRAM 3a, 3b, 3c of the above first group (“first rank”) of DRAMs 3a, 3b, 3c of a respective FBDIMM 2a, 2b, 2c is to be accessed, the respective buffer component 5a, 5b, 5c of the respective FBDIMM 2a, 2b, 2c sends respective first Chip Select Signals CS0 to the DRAMs of the first group (“first rank”) of DRAMs 3a, 3b, 3c of the respective FBDIMM 2a, 2b, 2c. If in contrast a DRAM 3a, 3b, 3c of the above second group (“second rank”) of DRAMs 3a, 3b, 3c of a respective FBDIMM 2a, 2b, 2c is to be accessed, the respective buffer component 5a, 5b, 5c of the respective FBDIMM 2a, 2b, 2c sends respective second Chip Select Signals CS1 to the DRAMs of the second group (“second rank”) of DRAMs 3a, 3b, 3c of the respective FBDIMM 2a, 2b, 2c. The Chip Select Signals (CS0, CS1) are driven by the buffer component 5a, 5b, 5c on respective non-shared, separate chip select command lines 9a, 9b, 9c, and 8a, 8b, 8c. The chip select command lines 9a, 9b, 9c on which the first Chip Select Signals CS0 are provided are connected with a respective first chip select pin of the respective buffer component 5a, 5b, 5c and with respective chip select pins of the DRAMs 3a, 3b, 3c of the above first group (“first rank”) of DRAMs 3a, 3b, 3c. Correspondingly similar, the chip select command lines 8a, 8b, 8c on which the second Chip Select Signals CS1 are provided are connected with a respective second chip select pin of the respective buffer component 5a, 5b, 5c and with respective chip select pins of the DRAMs of the above second group (“second rank”) of DRAMs 3a, 3b, 3c.

If instead of the above “dual ranked” FBDIMMs 2a, 2b, 2c, each having a “first rank” and a “second rank” of DRAMs 3a, 3b, 3c e.g. FBDIMMs with four ranks are used, instead of the above first and second Chip Select Signals CS0, CS1 four separate Chip Selects Signals are necessary to access the DRAMs. For this purpose, two instead of one buffer component might be provided on each FBDIMM. However, this might lead to increased costs for a FBDIMM, and/or to problems as far as signal routing, thermal management, etc. are concerned.

For these or other reasons, there is a need for the present invention.

### SUMMARY

For these or other reasons, there is a need for the present invention. One embodiment provides, a device for use with a memory system. The device includes generating a second number of chip select signals from a first number of chip select signals, the first number of chip select signals being smaller, than the second number of chip select signals. According to another embodiment, a memory system may include at least one buffered memory module, and a device for generating a first and a second chip select signal from one single chip select signal, and/or for generating a third and a fourth chip select signal from the one single chip select signal and/or an additional single chip select signal. Further features and advantages of the present invention will become apparent from the following detailed description of the invention made with reference to the accompanying drawings.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate embodiments of the present invention and together with the description serve to explain the principles of the invention. Other embodiments of the present invention and many of the intended advantages of the present invention will be readily appreciated as they become better understood by reference to the following detailed description.

FIG. 1 illustrates a conventional memory system with buffered memory modules.

FIG. 2 illustrates a memory system with buffered memory modules according to an embodiment of the present invention.

FIG. 3 illustrates a more detailed view of a buffered memory module according to an embodiment of the present invention.

FIG. 4 illustrates a schematic view of a Chip Select Signal Converting Device according to an embodiment of the present invention.

### DETAILED DESCRIPTION

In the following Detailed Description, reference is made to the accompanying drawings, which form a part hereof, and in which is illustrated by way of illustration specific embodiments in which the invention may be practiced. It is to be understood that other embodiments may be utilized and structural or other changes may be made without departing from the scope of the present invention. The following detailed description, therefore, is not to be taken in a limiting sense, and the scope of the present invention is defined by the appended claims.

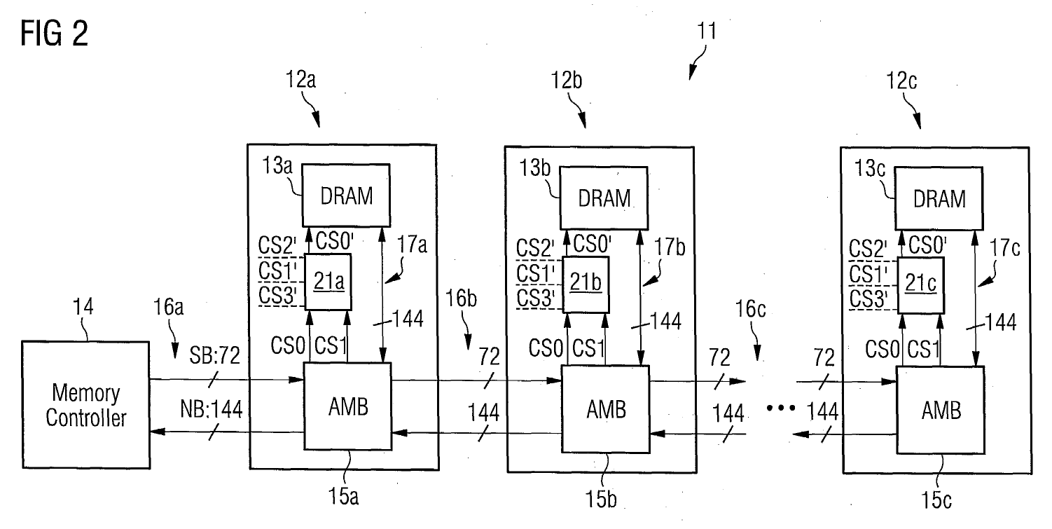

FIG. 2 illustrates a memory system 11 with buffered memory modules 12a, 12b, 12c according to an embodiment of the present invention.

As is illustrated in FIG. 2, several, e.g. more than three, seven, or fifteen, e.g. up to eight memory modules 12a, 12b, 12c, e.g. respective memory cards/FBDIMMs (Fully Buffered DIMMs) 12a, 12b, 12c per channel may be connected to a memory controller 14. The memory controller 14 in turn may be connected via one or several buses to one or several microprocessors (not illustrated). For sake of simplicity, FIG. 2 only depicts one single channel. The system 11 may comprise more than the one channel illustrated in FIG. 2, e.g. more than two or four channels, each having—just as the channel illustrated in FIG. 2—several, e.g. more than three, seven, or fifteen, e.g. up to eight memory modules/FBDIMMs (Fully Buffered DIMMs).

Each FBDIMM 12a, 12b, 12c includes one or several buffer components 15a, 15b, 15c, and several RAM devices 13a, 13b, 13c, in particular e.g. DRAMs or SRAMs, e.g. more than three, seven, or fifteen, for instance eight or sixteen DRAMs, e.g. DDR2- or DDR3-DRAMs (for sake of simplicity, in FIG. 2 only one DRAM per memory card/FBDIMM 12a, 12b, 12c is illustrated).

Each DRAM may e.g. have a storage capacity of e.g. 128 MBit, 256 MBit, 512 MBit, 1 GBit, 2 Gbit, etc. (or more); the total storage capacity provided by a corresponding FBDIMM 12a, 12b, 12c depends on the number of DRAMs provided on a FBDIMM, and on the storage capacity of the individual DRAMs, and is, for instance, 1 GByte, 2 GByte, etc. (or more).

Each FBDIMM 12a, 12b, 12c might e.g. comprise a first group of DRAMs (“first rank”), and e.g. a second group of DRAMs (“second rank”), and at least one further group of DRAMs, e.g. a third group of DRAMs (“third rank”), and a fourth group of DRAMs (“fourth rank”) (and alternatively one or more additional groups of DRAMs/additional ranks). The first and second group of DRAMs (or e.g. the first and third group of DRAMs, etc.) may e.g. be positioned at a front side (and/or a back side) of a respective FBDIMM 12a, 12b, 12c, and the third and fourth group of DRAMs (or e.g. the second and fourth group of DRAMs, etc.) e.g. at the back side (and/or the front side) of a respective FBDIMM 12a, 12b, 12c, etc.

The FBDIMMs 12a, 12b, 12c may e.g. be plugged into corresponding sockets of a motherboard, which e.g. may also comprise the above memory controller 14, and/or the above microprocessor(s).

As is illustrated in FIG. 2, the memory controller 14 may be connected to a first FBDIMM 12a (“DIMM 1”) of the FBDIMMs 12a, 12b, 12c via a first bus 16a provided on the above motherboard, having a first channel (“south-bound channel” (SB channel)), and a second channel (“north-bound channel” (NB channel)). The SB channel of the bus 16a is used to send respective address, command, and data signals from the memory controller 14 (and/or the above microprocessor(s)) to the buffer component 15a of the first FBDIMM 12a. Correspondingly similar, the NB channel of the bus 16a is used to send respective signals from the buffer component 15a of the first FBDIMM 12a to the memory controller 14 (and/or the above microprocessor(s)).

As is further illustrated in FIG. 2, the first FBDIMM 12a of the FBDIMMs 12a, 12b, 12c is connected to a second FBDIMM 12b (“DIMM 2”) of the FBDIMMs 12a, 12b, 12c via a second bus 16b, which just as the bus 16a includes a first channel (“south-bound channel” (SB channel)), and a second channel (“north-bound channel” (NB channel)), and the second FBDIMM 12b of the FBDIMMs 12a, 12b, 12c is connected to a third FBDIMM via a third bus 16c (also having a first channel (“south-bound channel” (SB channel)), and a second channel (“north-bound channel” (NB channel))), etc., etc.

The memory system 11 in addition to the above FBDIMMs 12a, 12b, 12c, and the memory controller 14 may comprise a system clock generator (not illustrated). The system clock generator may generate respective individual clock signals for the memory controller 14, and each of the FBDIMMs 12a, 12b, 12c. The timing of the clock signals provided by the system clock generator might be such that for the whole memory system 11, i.e., each of the FBDIMMs 12a, 12b, 12c, as well as the memory controller 14 a unique common timing scheme is provided. Many other ways of generating/providing respective clock signals and/or a unique common timing scheme are also possible. For instance, the memory controller 14 might generate a clock signal, which is provided to the first FBDIMM 12a, from where the clock signal—where required after a respective re-generation—is provided to the second FBDIMM 12b, and from the second FBDIMM 12b to the third FBDIMM, etc., etc.

The FBDIMMs 12a, 12b, 12c work according to the “daisy chain” principle. The buffer component 15a of the first FBDIMM 12a of the FBDIMMs 12a, 12b, 12c relays the respective address, command, and data signals received via the “south-bound channel” of the first bus 16a from the microprocessor/memory controller 14—where required after a respective re-generation—via the “south-bound channel” of the second bus 16b to the buffer component 15b of the second FBDIMM 12b. Correspondingly similar, the buffer component 15b of the second FBDIMM 12b of the FBDIMMs 12a, 12b, 12c relays the respective address, command, and data signals received via the “south-bound channel” of the second bus 16b from the first FBDIMM 12a—where required after a respective re-generation—via the “south-bound channel” of the third bus 16c to the buffer component 15c of the third FBDIMM 12c, etc., etc.

Correspondingly inversely, the buffer component 15b of the second FBDIMM 12b of the FBDIMMs 12a, 12b, 12c relays the respective signals received via the “north-bound channel” of the third bus 16c from the above third FBDIMM—where required after a respective re-generation—via the “north-bound channel” of the second bus 16b to the buffer component 15a of the first FBDIMM 12a, and the buffer component 15a of the first FBDIMM 12a of the FBDIMMs 12a, 12b, 12c relays the respective signals received via the “north-bound channel” of the second bus 16b from the above second FBDIMM 12b—where required after a respective re-generation—via the “north-bound channel” of the first bus 16a to the microprocessor/memory controller 14.

As is further illustrated in FIG. 2, and correspondingly similar as is the case in conventional memory systems, each of the RAM devices, in particular e.g. DRAMs or SRAMs, e.g. DDR2- or DDR3-DRAMs 13a, 13b, 13c provided on the above FBDIMMs 12a, 12b, 12c is connected to the corresponding buffer component(s) 15a, 15b, 15c provided on a respective FBDIMM 12a, 12b, 12c via a bus 17a, 17b, 17c, e.g., a respective stub-bus.

According to FIG. 2, the stub-buses 17a, 17b, 17c on the FBDIMMs 12a, 12b, 12c, and the north bound channels of the buses 16a, 16b, 16c may e.g. comprise the same data bandwidth, e.g. a data bandwidth of 144 bits per DRAM clock period. Further, the south bound channels of the buses 16a, 16b, 16c might e.g. comprise a lower data bandwidth as the north bound channels, and the stub-buses 17a, 17b, 17c on the FBDIMMs 12a, 12b, 12c, e.g., half the data bandwidth of the north bound channels and the stub-buses 17a, 17b, 17c, e.g. a data bandwidth of 72 bits per DRAM clock period. Many other data bandwidths for the north and south bound channels of the buses 16a, 16b, 16c, and the stub-buses 17a, 17b, 17c (and many other relations between the respective data bandwidths than the ones mentioned by way of example above) are also possible.

Each buffer component 15a, 15b, 15c of the FBDIMMs 12a, 12b, 12c knows its position in the above daisy chain. Which of the FBDIMMs 12a, 12b, 12c is being accessed at a certain time by the memory controller 14 may e.g. be determined in the respective buffer component 15a, 15b, 15c by comparing memory module identification data stored there (e.g., an “ID number”) with identification data sent by the memory controller 14 via the above buses 16a, 16b, 16c, e.g. via one or several separate address and/or command lines of the above buses 16a, 16b, 16c.

After a certain buffer component 15a, 15b, 15c has determined that the corresponding FBDIMM 12a, 12b, 12c is to be accessed, the corresponding buffer component does not only relay the address, command, and data signals received via a respective south-bound channel of one of the buses 16a, 16b, 16c to the next buffer component in the daisy chain (as explained above), but also relays the signals (where appropriate, in converted form) via the above stub-bus to the RAMs provided on the accessed FBDIMM. Further, signals received by a respective buffer component 15a, 15b, 15c via the above stub-bus from an accessed RAM are relayed (where appropriate, in converted form) via a respective north bound channel of one of the buses 16a, 16b, 16c to the previous buffer component in the daisy chain (or—by the buffer component 15a of the first the FBDIMM 12a—to the memory controller 14).

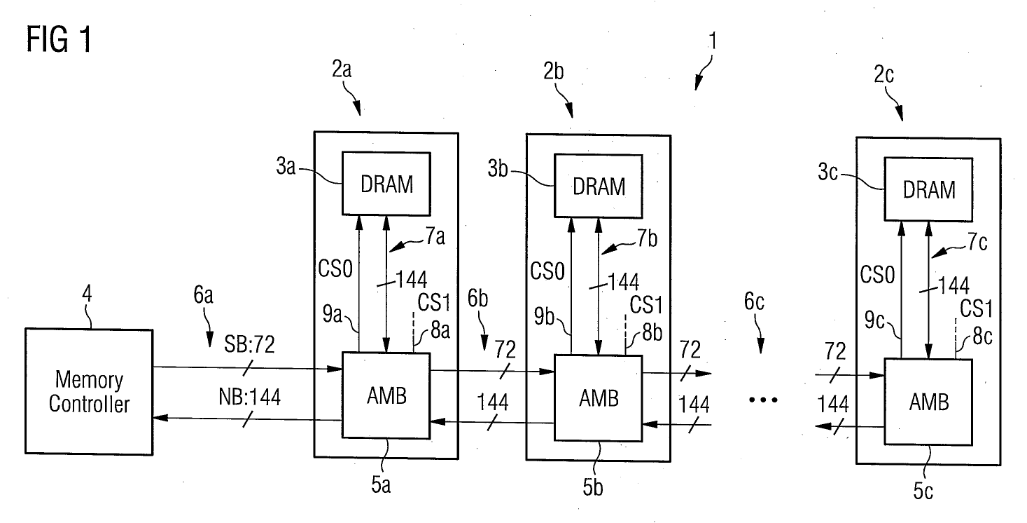

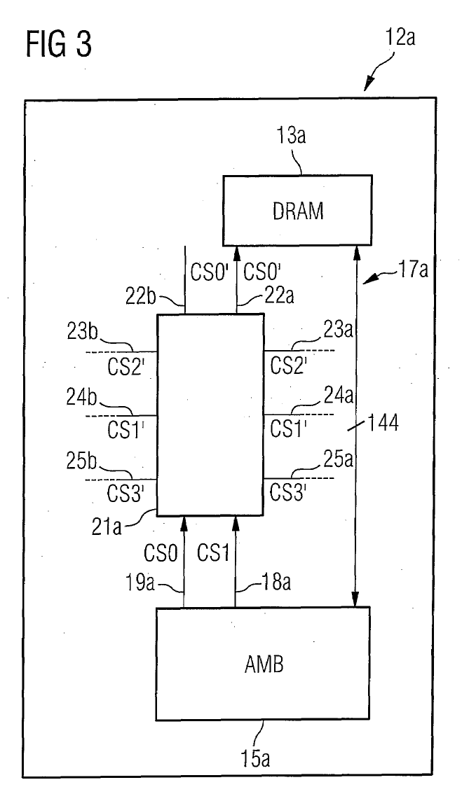

As is illustrated in FIGS. 2 and 3, and as will be described in further detail below, in the memory system 11, even though each FBDIMM 12a, 12b, 12c includes more than two groups/ranks of DRAMs (here e.g. the above-mentioned first, second, third and fourth groups/ranks of DRAMs (“first rank”, “second rank”, “third rank”, “fourth rank”)) each buffer component 15a, 15b, 15c—just as conventional buffer components 5a, 5b, 5c as e.g. illustrated in FIG. 1—only includes two chip select pins.

As is further illustrated in FIGS. 2 and 3, the first chip select pin of a respective buffer component 15a, 15b, 15c is connected with a respective first non-shared, separate chip select command line 19a, 19b, 19c, on which a first Chip Select Signal CS0 may be provided by the respective buffer component 15a, 15b, 15c. Correspondingly similar, the second chip select pin of a respective buffer component 15a, 15b, 15c is connected with a respective second non-shared, separate chip select command line 18a, 18b, 18c, on which a second Chip Select Signal CS1 may be provided by the respective buffer component 15a, 15b, 15c.

The respective buffer component 15a, 15b, 15c correspondingly similar as a conventional dual ranked buffer component generates the Chip Select Signals CS0, CS1 in response to respective first and second Chip Select Signals CS0″, CS1″ received from the memory controller and/or microprocessor(s) 14 via the above bus 16a, 16b, 16c at e.g. a time N, i.e. during a “Rank selection phase”. For instance, if the first Chip Select Signal CS0″ received from the memory controller and/or microprocessor(s) 14 via the above bus 16a, 16b, 16c at the time N is “1” or “logic high” (and the second Chip Select Signal CS1″ is “0” or “logic low”), the respective buffer component 15a, 15b, 15c might e.g. change the state of the chip select command lines 19a, 19b, 19c from “logic low” to “logic high” (or inverse), whilst leaving the state of the further chip select command lines 18a, 18b, 18c “logic low” (or “logic high”), issuing the above first Chip Select Signal CS0 on the chip select command lines 19a, 19b, 19c. Further, in contrast, if the second Chip Select Signal CS1″ received from the memory controller and/or microprocessor(s) 14 via the above bus 16a, 16b, 16c at e.g. the time N is “1” or “logic high” (and the first Chip Select Signal CS0″ is “0” or “logic low”), the respective buffer component 15a, 15b, 15c might e.g. change the state of the chip select command lines 18a, 18b, 18c from “logic low” to “logic high” (or inverse), whilst leaving the state of the chip select command lines 19a, 19b, 19c “logic low” (or “logic high”), issuing the above second Chip Select Signal CS1 on the chip select command lines 18a, 18b, 18c.

The first non-shared, separate chip select command line 19a, 19b, 19c (connected with the first chip select pin of a respective buffer component 15a, 15b, 15c) is connected with a first input of a Chip Select Signal Converting Device 21a, 21b, 21c. Correspondingly similar, the second non-shared, separate chip select command line 18a, 18b, 18c (connected with the second chip select pin of a respective buffer component 15a, 15b, 15c) is connected with a second input of the Chip Select Signal Converting Device 21a, 21b, 21c.

As will be described in further detail below, the Chip Select Signal Converting Device 21a, 21b, 21c converts the two Chip Select Signals (here: the above first Chip Select Signal CS0, and the above second Chip Select Signal CS1) received on the above first and second chip select command lines 19a, 19b, 19c, and 18a, 18b, 18c into a higher number of (converted) Chip Select Signals (here: four converted Chip Select Signals (namely, a first converted Chip Select Signal CS0′, a second converted Chip Select Signal CS1′, a third converted Chip Select Signal CS2′, and a fourth converted Chip Select Signal CS3′)). The number of converted Chip Select Signals generated by the Chip Select Signal Converting Device 21a, 21b, 21c advantageously corresponds to the number of Chip Select Signals necessary to access the groups/ranks of DRAMs provided on the FBDIMMs 12a, 12b, 12c. In particular, the number of converted Chip Select Signals generated by the Chip Select Signal Converting Device 21a, 21b, 21c may be identical to the number of groups/ranks of DRAMs provided on the FBDIMMs 12a, 12b, 12c.

As is illustrated in FIG. 2 and 3, the buffer component 15a and the Chip Select Signal Converting Device 21a might be provided on separate integrated circuit chips. Alternatively, the function of both the buffer component 15a and the Chip Select Signal Converting Device 21a might be provided by one single integrated circuit chip. In a further alternative, instead of providing one single integrated circuit chip per FBDIMM 12a functioning as Chip Select Signal Converting Device 21a, the function of the Chip Select Signal Converting Device 21a might also be performed by several separate integrated circuit chips, e.g., several multiplexing switches, etc. (see below).

As also will be described in further detail below, if a DRAM 13a, 13b, 13c of the above first group (“first rank”) of DRAMs 13a, 13b, 13c of a respective FBDIMM 12a, 12b, 12c is to be accessed (e.g., if a respective read or write access is to be carried out), the Chip Select Signal Converting Device 21a, 21b, 21c of the respective FBDIMM 12a, 12b, 12c converts the Chip Select Signals CS0, CS1 received on the above chip select command lines 19a, 19b, 19c, and 18a, 18b, 18c into the above first (converted) Chip Select Signal CS0′. As is illustrated in FIGS. 2 and 3, this first converted Chip Select Signal CS0′ is sent out to the DRAMs of the first group (“first rank”) of DRAMs 13a, 13b, 13c of the respective FBDIMM 12a, 12b, 12c via respective non-shared command lines 22a, 22b, etc. For “sending out” the first Chip Select Signal CS0′ (accessing the first rank of DRAMs), the Chip Select Signal Converting Device 21a, 21b, 21c might e.g. change the state of the respective command lines 22a, 22b from “logic low” to “logic high” (or inverse), whilst leaving the state of further non-shared command lines 23a, 23b, 24a, 24b, 25a, 25b (see below) “logic low” (or “logic high”).

If in contrast a DRAM of the above second group (“second rank”) of DRAMs 13a, 13b, 13c of a respective FBDIMM 12a, 12b, 12c is to be accessed (e.g., if a respective read or write access is to be carried out), the Chip Select Signal Converting Device 21a, 21b, 21c of the respective FBDIMM 12a, 12b, 12c converts the Chip Select Signals CS0, CS1 received on the above chip select command lines 19a, 19b, 19c, and 18a, 18b, 18c into the above second converted Chip Select Signal CS1′. This second converted Chip Select Signal CS1′ is sent out to the DRAMs of the second group (“second rank”) of DRAMs 13a, 13b, 13c of the respective FBDIMM 12a, 12b, 12c via respective non-shared command lines 24a, 24b, etc. For “sending out” the second Chip Select Signal CS1′ (accessing the second rank of DRAMs), the Chip Select Signal Converting Device 21a, 21b, 21c might e.g. change the state of the respective command lines 24a, 24b from “logic low” to “logic high” (or inverse), whilst leaving the state of further non-shared command lines 22a, 22b, 23a, 23b, 25a, 25b “logic low” (or “logic high”).

Correspondingly similar, if a DRAM of the above third group (“third rank”) of DRAMs 13a, 13b, 13c of a respective FBDIMM 12a, 12b, 12c is to be accessed (e.g., if a respective read or write access is to be carried out), the Chip Select Signal Converting Device 21a, 21b, 21c of the respective FBDIMM 12a, 12b, 12c converts the Chip Select Signals CS0, CS1 received on the above chip select command lines 19a, 19b, 19c, and 18a, 18b, 18c into the above third converted Chip Select Signal CS2′. This third converted Chip Select Signal CS2′ is sent out to the DRAMs of the third group (“third rank”) of DRAMs 13a, 13b, 13c of the respective FBDIMM 12a, 12b, 12c via respective non-shared command lines 23a, 23b, etc. For “sending out” the third Chip Select Signal CS2′ (accessing the third rank of DRAMs), the Chip Select Signal Converting Device 21a, 21b, 21c might e.g. change the state of the respective command lines 23a, 23b from “logic low” to “logic high” (or inverse), whilst leaving the state of further non-shared command lines 22a, 22b, 24a, 24b, 25a, 25b “logic low” (or “logic high”).

If however a DRAM of the above fourth group (“fourth rank”) of DRAMs 13a, 13b, 13c of a respective FBDIMM 12a, 12b, 12c is to be accessed (e.g., if a respective read or write access is to be carried out), the Chip Select Signal Converting Device 21a, 21b, 21c of the respective FBDIMM 12a, 12b, 12c converts the Chip Select Signals CS0, CS1 received on the above chip select command lines 19a, 19b, 19c, and 18a, 18b, 18c into the above fourth converted Chip Select Signal CS3′. This fourth converted Chip Select Signal CS3′ is sent out to the DRAMs of the fourth group (“fourth rank”) of DRAMs 13a, 13b, 13c of the respective FBDIMM 12a, 12b, 12c via respective non-shared command lines 25a, 25b, etc. For “sending out” the fourth Chip Select Signal CS3′ (accessing the fourth rank of DRAMs), the Chip Select Signal Converting Device 21a, 21b, 21c might e.g. change the state of the respective command lines 25a, 25b from “logic low” to “logic high” (or inverse), whilst leaving the state of the further non-shared command lines 22a, 22b, 23a, 23b, 24a, 24b “logic low” (or “logic high”).

As is further illustrated in FIGS. 2 and 3, the command lines 22a, 22b on which the above first converted Chip Select Signal CS0′ is provided by the Chip Select Signal Converting Device 21a, 21b, 21c are connected with respective chip select pins of the DRAMs 13a, 13b, 13c of the above first group (“first rank”) of DRAMs 13a, 13b, 13c. For example, the command line 22a may be connected with first rank DRAMs on the above front side of the respective FBDIMM 12a, 12b, 12c, and the command line 22b with first rank DRAMs on the above back side of the respective FBDIMM 12a, 12b, 12c.

Correspondingly similar, the command lines 24a, 24b on which the above second converted Chip Select Signal CS1′ is provided by the Chip Select Signal Converting Device 21a, 21b, 21c are connected with respective chip select pins of the DRAMs 13a, 13b, 13c of the above second group (“second rank”) of DRAMs 13a, 13b, 13c. For example, the command line 24a may be connected with second rank DRAMs on the above front side of the respective FBDIMM 12a, 12b, 12c, and the command line 24b with second rank DRAMs on the above back side of the respective FBDIMM 12a, 12b, 12c.

Further, the command lines 23a, 23b on which the above third converted Chip Select Signal CS2′ is provided by the Chip Select Signal Converting Device 21a, 21b, 21c are connected with respective chip select pins of the DRAMs 13a, 13b, 13c of the above third group (“third rank”) of DRAMs 13a, 13b, 13c. Correspondingly similar, the command lines 25a, 25b on which the above fourth converted Chip Select Signal CS3′ is provided by the Chip Select Signal Converting Device 21a, 21b, 21c are connected with respective chip select pins of the DRAMs 13a, 13b, 13c of the above fourth group (“fourth rank”) of DRAMs 13a, 13b, 13c. For example, the command line 23a may be connected with third rank DRAMs on the above front side of the respective FBDIMM 12a, 12b, 12c, the command line 23b with third rank DRAMs on the above back side of the respective FBDIMM 12a, 12b, 12c, the command line 25a with fourth rank DRAMs on the above front side of the respective FBDIMM 12a, 12b, 12c, and the command line 25b with fourth rank DRAMs on the above back side of the respective FBDIMM 12a, 12b, 12c.

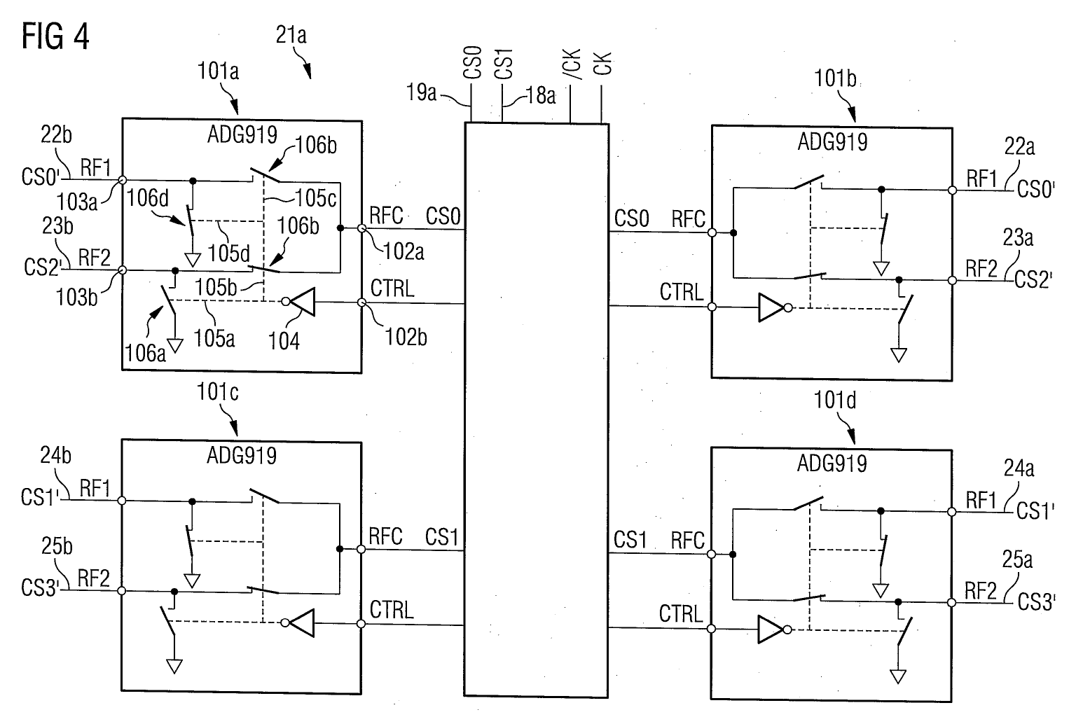

As is illustrated in FIG. 4, the Chip Select Signal Converting Device 21a, 21b, 21c includes several (here: four identical) multiplexing switches 101a, 101b, 101c, 101d.

Each multiplexing switch 101a, 101b, 101c, 101d includes a first input 102a (RFC input) and a second input 102b (control input (CTRL input)), and a first output 103a (RF1 output) and a second output 103b (RF2 output).

The second input 102b is connected with an inverter 104. The inverter 104 inverts the signal present at the second input 102b, and—after a certain delay—outputs a respectively inverted signal. As can be seen from FIG. 4, the output of the inverter 104 controls—e.g. via a respective control logic (not illustrated), and a line 105a—the state of a first switch 106a, as well as—via the control logic (not illustrated), and a line 105b—the state of a second switch 106b, and—via the control logic, and a line 105c—the state of a third switch 106c, and—via the control logic, and a line 105d—the state of a fourth switch 106d. The switches 106a, 106b, 106c, 106d e.g. may comprise transistors.

As can be seen from FIG. 4, to the first input 102a (RFC input) of the first multiplexing switch 101a, and to the first input (RFC input) of the second multiplexing switch 101b the Chip Select Signal CS0 (i.e., the above first Chip Select Signal CS0 present on the above line 19a) is provided from the respective buffer component 15a.

Correspondingly similar, to the first input (RFC input) of the third multiplexing switch 101c, and to the first input (RFC input) of the fourth multiplexing switch 101d the Chip Select Signal CS1 (i.e., the above second Chip Select Signal CS1 present on the above line 18a) is provided from the respective buffer component 15a.

As can be further seen from FIG. 4, the first output 103a (RF1 output) of the (first) multiplexing switch 101a is connected with the above command line 22b, and the first output (RF1 output) of the (second) multiplexing switch 101b is connected with the above command line 22a.

Further, the second output 103b (RF2 output) of the (first) multiplexing switch 101a is connected with the above command line 23b, and the second output (RF2 output) of the (second) multiplexing switch 101b is connected with the above command line 23a.

Correspondingly similar, the first output (RF1 output) of the (third) multiplexing switch 101c is connected with the above command line 24b, and the first output (RF1 output) of the (fourth) multiplexing switch 101d is connected with the above command line 24a.

In addition, the second output (RF2 output) of the (third) multiplexing switch 101c is connected with the above command line 25b, and the second output (RF2 output) of the (fourth) multiplexing switch 101d is connected with the above command line 25a.

If a DRAM 13a, 13b, 13c of the above first group (“first rank”) of DRAMs 13a, 13b, 13c of a respective FBDIMM 12a, 12b, 12c is to be accessed (e.g., if a respective read or write access is to be carried out), the Chip Select Signal Converting Device 21a, 21b, 21c of the respective FBDIMM 12a, 12b, 12c converts the first Chip Select Signal CS0 received on the above chip select command lines 19a, 19b, 19c from the respective buffer component 15a by relaying the first Chip Select Signal CS0 via the first multiplexing switch 101a to the above command line 22b, and via the second multiplexing switch 101b to the above command line 22a (however, not to e.g. the above command lines 23b and 23a).

For this purpose, the first and second multiplexing switches 101a, 101b are brought into a state where the first switch 106a is closed, the second switch 106b is open, the third switch 106c is closed, and the fourth switch 106d is open. In this case, the first inputs 102a of the multiplexing switches 101a, 101b are connected—via the third switches 106c—to the first outputs 103a of the multiplexing switches 101a, 101b. Further, the second outputs 103b of the multiplexing switches 101a, 101b are connected—via the first switches 106a—to ground. To achieve this, as will be described in further detail below, appropriate control signals are applied by the Chip Select Signal Converting Device 21a, 21b, 21c (or e.g. a control circuitry thereof) to the above second inputs 102b (control inputs (CTRL input)) of the multiplexing switches 101a, 101b, 101c, 101d.

If however a DRAM 13a, 13b, 13c of the above second group (“second rank”) of DRAMs 13a, 13b, 13c of a respective FBDIMM 12a, 12b, 12c is to be accessed (e.g., if a respective read or write access is to be carried out), the Chip Select Signal Converting Device 21a, 21b, 21c of the respective FBDIMM 12a, 12b, 12c converts the second Chip Select Signal CS1 received on the above chip select command lines 18a, 18b, 18c from the respective buffer component 15a by relaying the second Chip Select Signal CS1 via the third multiplexing switch 101c to the above command line 24b, and via the fourth multiplexing switch 101d to the above command line 24a (however, not to e.g. the above command lines 25b and 25a).

For this purpose, the third and fourth multiplexing switches 101c, 101d are brought into a state where the first switch is closed, the second switch is open, the third switch is closed, and the fourth switch is open. In this case, the first inputs of the multiplexing switches 101c, 101d are connected—via the third switches—to the first outputs of the multiplexing switches 101c, 101d. Further, the second outputs of the multiplexing switches 101c, 101d are connected—via the first switches—to ground. To achieve this, again, appropriate control signals are applied by the Chip Select Signal Converting Device 21a, 21b, 21c to the above second inputs 102b (control inputs (CTRL input)) of the multiplexing switches 101a, 101b, 101c, 101d.

If a DRAM 13a, 13b, 13c of the above third group (“third rank”) of DRAMs 13a, 13b, 13c of a respective FBDIMM 12a, 12b, 12c is to be accessed (e.g., if a respective read or write access is to be carried out), the Chip Select Signal Converting Device 21a, 21b, 21c of the respective FBDIMM 12a, 12b, 12c converts the first Chip Select Signal CS0 received on the above chip select command lines 19a, 19b, 19c from the respective buffer component 15a by relaying the first Chip Select Signal CS0 via the first multiplexing switch 101a to the above command line 23b, and via the second multiplexing switch 101b to the above command line 23a (however, not to e.g. the above command lines 22b and 22a).

For this purpose, the first and second multiplexing switches 101a, 101b are brought into a state where the first switch 106a is open, the second switch 106b is closed, the third switch 106c is open, and the fourth switch 106d is closed. In this case, the first inputs 102a of the multiplexing switches 101a, 101b are connected—via the second switches 106b—to the second outputs 103b of the multiplexing switches 101a, 101b. Further, the first outputs 103a of the multiplexing switches 101a, 101b are connected—via the fourth switches 106d—to ground. To achieve this, as will be described in further detail below, appropriate control signals are applied by the Chip Select Signal Converting Device 21a, 21b, 21c to the above second inputs 102b (control inputs (CTRL input)) of the multiplexing switches 101a, 101b, 101c, 101d.

If a DRAM 13a, 13b, 13c of the above fourth group (“fourth rank”) of DRAMs 13a, 13b, 13c of a respective FBDIMM 12a, 12b, 12c is to be accessed (e.g., if a respective read or write access is to be carried out), the Chip Select Signal Converting Device 21a, 21b, 21c of the respective FBDIMM 12a, 12b, 12c converts the second Chip Select Signal CS1 received on the above chip select command lines 18a, 18b, 18c from the respective buffer component 15a by relaying the second Chip Select Signal CS1 via the third multiplexing switch 101c to the above command line 25b, and via the fourth multiplexing switch 101d to the above command line 25a (however, not to e.g. the above command lines 24b and 24a).

For this purpose, the third and fourth multiplexing switches 101c, 101d are brought into a state where the first switch is open, the second switch is closed, the third switch is open, and the fourth switch is closed. In this case, the first inputs of the multiplexing switches 101c, 101d are connected—via the second switches—to the second outputs of the multiplexing switches 101c, 101d. Further, the first outputs of the multiplexing switches 101c, 101d are connected—via the fourth switches—to ground. To achieve this, again, appropriate control signals are applied by the Chip Select Signal Converting Device 21a, 21b, 21c to the above second inputs 102b (control inputs (CTRL input)) of the multiplexing switches 101a, 101b, 101c, 101c.

Whether the above first Chip Select Signal CS0 is to be relayed via the multiplexing switches 101a, 101b to the above lines 22a, 22b, or to the above lines 23a, 23b (i.e. whether the above first or third converted Chip Select Signal CS0′, CS2′ is to be provided) may be controlled by the state of the respective first and second Chip Select Signals CS0″, CS1″ received from the memory controller and/or microprocessor(s) 14 via the above bus 16a, 16b, 16c at a time N-1, directly preceding the above time N, i.e. during a “Rank command enable/disable phase”, directly preceding the above “Rank selection phase”. For instance, if the first and second Chip Select Signals CS0″, CS1″ received from the memory controller and/or microprocessor(s) 14 via the above bus 16a, 16b, 16c at the above time N-1 both are “0” or “logic low”, the first Chip Select Signal CS0 is to be relayed via the multiplexing switches 101a, 101b to the above lines 22a, 22b, i.e., the above first converted Chip Select Signal CS0′ is to be provided. In contrast, if the first and second Chip Select Signals CS0″, CS1″ received from the memory controller and/or microprocessor(s) 14 via the above bus 16a, 16b, 16c at the above time N-1 both are “1” or “logic high”, the first Chip Select Signal CS0 is to be relayed via the multiplexing switches 101a, 101b to the above lines 23a, 23b, i.e., the above third converted Chip Select Signal CS2′ is to be provided.

Correspondingly similar, whether the above second Chip Select Signal CS1 is to be relayed via the multiplexing switches 101c, 101d to the above lines 24a, 24b, or to the above lines 25a, 25b (i.e. whether the above second or fourth converted Chip Select Signal CS1′, CS3′ is to be provided) also may be controlled by the state of the respective first and second Chip Select Signals CS0″, CS1” received from the memory controller and/or microprocessor(s) 14 via the above bus 16a, 16b, 16c at the above time N-1, directly preceding the above time N, i.e. during a “Rank command enable/disable phase”, directly preceding the above “Rank selection phase”. For instance, if the first and second Chip Select Signals CS0″, CS1″ received from the memory controller and/or microprocessor(s) 14 via the above bus 16a, 16b, 16c at the above time N-1 both are “0” or “logic low”, the second Chip Select Signal CS1 is to be relayed via the multiplexing switches 101c, 101d to the above lines 24a, 24b, i.e., the above second converted Chip Select Signal CS1′ is to be provided. In contrast, if the first and second Chip Select Signals CS0″, CS1″ received from the memory controller and/or microprocessor(s) 14 via the above bus 16a, 16b, 16c at the above time N-1 both are “1” or “logic high”, the second Chip Select Signal CS1 is to be relayed via the multiplexing switches 101c, 101d to the above lines 25a, 25b, i.e., the above fourth converted Chip Select Signal CS3′ is to be provided.

With other words, if the first and second Chip Select Signals CS0″, CS1″ received from the memory controller and/or microprocessor(s) 14 via the above bus 16a, 16b, 16c at the above time N-1 both are “0” or “logic low”, issuance of the above first and second converted Chip Select Signals CS0′, CS1′ is enabled, and issuance of the above third and fourth converted Chip Select Signals CS2′, CS3′ is disabled. In contrast, if the first and second Chip Select Signals CS0″, CS1″ received from the memory controller and/or microprocessor(s) 14 via the above bus 16a, 16b, 16c at the above time N-1 both are “1” or “logic high”, issuance of the above first and second converted Chip Select Signals CS0′, CS1′ is disabled, and issuance of the above third and fourth converted Chip Select Signals CS2′, CS3′ is enabled.

The following table in summarized form illustrates the relation between the states of the above first and second Chip Select Signals CS0″, CS1″ received from the memory controller and/or microprocessor(s) 14, and the signals emitted on the above command lines 22a, 22b (i.e., the Chip Select Signal CS0′), the signals emitted on the above command lines 23a, 23b (i.e., the Chip Select Signal CS2′), the signals emitted on the above command lines 24a, 24b (i.e., the Chip Select Signal CS1′), and the signals emitted on the above command lines 25a, 25b (i.e., the Chip Select Signal CS3′) by the respective multiplexing switch:

| CK | CS0″ | CS1″ | CS0′ | CS1′ | CS2′ | CS3′ | Remark |
|---|---|---|---|---|---|---|---|
| N − 1 | 0 | 0 | 0 | 0 | 0 | 0 | Command for |
| | | | | | | | first and |
| | | | | | | | second Rank |
| | | | | | | | enabled |
| N | 1 | 0 | 1 | 0 | 0 | 0 | First rank |
| | | | | | | | selected |
| N | 0 | 1 | 0 | 1 | 0 | 0 | Second |
| | | | | | | | selected |
| N − 1 | 1 | 1 | 0 | 0 | 0 | 0 | Command for |
| | | | | | | | third and |
| | | | | | | | fourth Rank |
| | | | | | | | enabled |
| N | 1 | 0 | 0 | 0 | 1 | 0 | Third Rank |
| | | | | | | | selected |
| N | 0 | 1 | 0 | 0 | 0 | 1 | Fourth Rank |
| | | | | | | | selected |

As was explained above, each buffer component 15a, 15b, 15c—just as conventional two-rank buffer components 5a, 5b, 5c—only includes two chip select pins, even though the memory system 11 as described above is a four-rank memory system. Hence, correspondingly identical or similar packages might be used for the buffer components 15a, 15b, 15c as for conventional two-rank buffer components 5a, 5b, 5c as e.g. illustrated in FIG. 1. Further, the four-rank memory controller 14 is driven by the buffer components 15a, 15b, 15c in a correspondingly identical or similar way as the conventional two-rank memory controller 4 illustrated in FIG. 1. Still further, the memory controller 14—even though supporting the four-rank memory system 11—only has to drive two Chip Select Signals CS0″, CS1″.

The principle explained above—generating a second number of (control) signals, e.g., Chip Select Signals from a first number of (control) signals, e.g., Chip Select Signals, the first number of signals being smaller, than the second number of signals (e.g. by use of a Signal Converting Device corresponding to the Signal Converting Device 21a, 21b, 21c illustrated above)—might not only be applied to the above Chip Select Signals, but in principle in a corresponding or similar way as explained above to any kind of (control) signal, e.g., to ODT-signals, etc.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A memory system, comprising:
at least one buffered memory module; and
a device for generating at least a first and a second chip select signal, and a third and a fourth chip select signal from one single chip select signal and an additional single chip select signal.

2. The memory system of claim 1, the buffered memory module comprising: a first rank of RAMs selectable with the first chip select signal; a second rank of RAMs selectable with the second chip select signal, a third rank of RAMs selectable with the third chip select signal, and a fourth rank of RAMs selectable with the fourth chip select signal.

3. The memory system of claim 2, comprising where the single chip select signal and the additional single chip select signal, or a first and a second signal from which the single and the additional single chip select signals are generated are configured to enable or disable selection of the first rank of RAMs, the second rank of RAMs, the third rank of RAMs, or the fourth rank of RAMs in a rank selection enabling/disabling phase of the memory system.

4. The memory system of claim 3, in which the single chip select signal and the additional single chip select signal, or the first and the second signals are adapted to select in a rank selecting phase of the memory system a rank of RAMs enabled for selection in the rank selection enabling/disabling phase of the memory system.

5. The memory system of claim 1, wherein the at least one buffered memory module comprises at least one RAM.

6. The memory system of claim 5, wherein the at least one buffered memory module comprises at least one DRAM.

7. The memory system of claim 1, wherein the at least one memory module comprises at least one buffer component.

8. The memory system of claim 1, configured to comprise a variably adjustable number of memory modules.

9. The memory system of claim 1, additionally comprising a memory controller connected with the at least one buffered memory module via a first bus.

10. The memory system of claim 9, wherein the at least one buffered memory module is connected with a further buffered memory module via a second bus.

11. The memory system of claim 10, wherein the at least one and the further buffered memory module each comprise at least one DRAM, the DRAM of the at least one buffered memory module being connected with a buffer component of the at least one buffered memory module via a third bus, and the DRAM of the further buffered memory module being connected with a buffer component of the further buffered memory module via a fourth bus.

12. A method for operating a memory system, the memory system comprising at least one memory module, the method comprising:
generating a first and a second chip select signal from one single chip select signal; and
generating a third and a fourth chip select signal from an additional single chip select signal.

13. The method of claim 12, comprising generating the first chip select signal for selecting a first rank of RAMs.

14. The method of claim 13, comprising generating the second chip select signal for selecting a second rank of RAMs.

15. The method of claim 14, comprising generating the third chip select signal for selecting a third rank of RAMs.

16. The method of claim 15, comprising the fourth chip select signal for selecting a fourth rank of RAMs.

17. The method of claim 12, comprising wherein in a rank selection enabling/disabling phase of the memory module the single chip select signal is brought in a first state, and the additional single chip select signal is brought in a first state for enabling selection of a first and a second rank of RAMs, and for disabling selection of a third and fourth rank of RAMs.

18. The method of claim 17, comprising wherein in the rank selection enabling/disabling phase the single chip select signal is brought in a second state, different from the first state of the single chip select signal, and the additional single chip select signal is brought in a second state, different from the first state of the additional single chip select signal for disabling selection of the first and the second rank of RAMs, and for enabling selection of the third and the fourth rank of RAMs.

19. A device for use with a memory system, comprising: where the device is configured for generating a second number of chip select signals from a first number of chip select signals, the first number of chip select signals being smaller, than the second number of chip select signals.

20. The device of claim 19, the second number of chip select signals being bigger than 1.

21. The device of claim 19, the second number of chip select signals being bigger than 3.

22. The device of claim 21, the second number of chip select signals being 4.

23. The device of claim 19, the second number of chip select signals being bigger than 5.

24. A device for use with a memory system, comprising: where the device is configured for generating a second number of control signals from a first number of control signals, the first number of control signals being smaller, than the second number of control signals.

25. A memory system, comprising:
at least one buffered memory module, the buffered memory module comprising:
a buffer component; and
a device for generating at least a first and a second chip select signal from one single chip select signal.

26. A memory system, comprising:
at least one buffered memory module; and
means for generating at least a first and a second chip select signal, and a third and a fourth chip select signal from one single chip select signal and an additional single chip select signal.
